(19) United States
(12) Patent Application Publication
(10) Pub. No.: US 2025/0363422 A1
(43) Pub. Date: Nov. 27, 2025

(54) COLLABORATIVE MACHINE LEARNING MODEL GENERATION FOR POTENTIAL ACTION SELECTION

(71) Applicant: U.S. Bancorp, National Association, Minneapolis, MN (US)

(72) Inventors: Rahul Sharma, Fremont, CA (US); Narasimha 'Murthy' M. Kunchakarra, Fremont, CA (US)

(73) Assignee: U.S. Bancorp, National Association, Minneapolis, MN (US)

(21) Appl. No.: 18/670,710

(22) Filed: May 21, 2024

(51) Int. Cl. G06N 20/20

(52) U.S. Cl. CPC G06N 20/20

(57) ABSTRACT

A system includes one or more processors to receive a first machine learning model from a first computing device (e.g., a neural network, support vector machine, random forest, etc.) and a second machine learning model from a second computing device; execute the first machine learning model to generate a first recommendation and the second machine learning model to generate a second recommendation; adjust one or more weights or parameters of the second machine learning model; receive a request for one or more potential actions at a first user interface presented on a display of the client device; execute the second machine learning model using an account identifier of a user account being used to access the application; and generate a second user interface on the display of the client device comprising the one or more potential actions.

### BACKGROUND

Within the realm of digital actions abundant with data, the significance of smart predictive models cannot be overstated, as they play a crucial role in enhancing efficiency and fostering value. These models form elements of recommendation systems, which can be customized to propose or identify potential recommendations by analyzing a user's past actions and anticipated future trends. However, employing conventional training techniques and approaches may constrain the precision, resilience, or adaptability of these recommendations, owing to limitations inherent in a model's configuration or parameters.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates an example system for collaborative machine learning model generation, in accordance with an implementation;

FIG. 2 illustrates an example system for collaborative machine learning model generation, in accordance with an implementation;

FIG. 3 illustrates an example sequence for collaborative machine learning model generation, in accordance with an implementation;

FIG. 4 illustrates an example sequence for collaborative machine learning model generation, in accordance with an implementation;

FIG. 5 illustrates an example sequence for collaborative machine learning model generation, in accordance with an implementation;

FIG. 6 illustrates an example method for collaborative machine learning model generation, in accordance with an implementation;

FIG. 7 discloses a computing environment in which aspects of the present disclosure may be implemented, in accordance with an implementation; and

FIG. 8 illustrates an example machine learning framework that techniques described herein may benefit from.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

As mentioned above, in the data-rich ecosystem of digital actions, the importance of intelligent predictive models that can accurately facilitate efficiency is paramount. These models are integral components of recommendation and other systems, which may be configured to suggest potential actions to users based on their historical behavior and predicted future behavior. Traditionally, these recommendation systems rely on single predictive models. However, this approach can limit the accuracy, robustness, and/or context-sensitivity of the suggestions due to the inherent constraints of relying on a single model's structure or parameters.

A computer implementing the systems and methods described herein can address the aforementioned technical deficiencies and provide machine learning models with improved accuracy and enhanced capabilities to handle complex relationships between features. The computer can do so using multiple machine learning models that are separately trained on different computing devices accessed by unique users to generate personalized recommendations for potential actions for the respective users. The computer can use one of the machine learning models as a ground truth to train another machine learning model for potential action recommendation generation, thus causing the further trained machine learning model to function as a predictive model for a blend of the two users that originally trained the two machine learning models. The trained machine learning model may later be used to generate potential action recommendations for a third user accessing the computer. The computer can train the machine learning model based on recommendations and selections by the third user. By using selections of three different users to train the machine learning model, the computer can improve the machine learning model's accuracy, reduce overfitting, facilitate better capture of complex relationships between input features, and improve noise filtering of input features, among other technical benefits.

In one example, the aforementioned multi-model system is relevant to providing a concrete solution to the limitations of single-model systems because it takes advantage of the strengths and mitigates the weaknesses of separately trained models. In addition, the system can personalize the recommendations to individual user accounts, maximizing the system's efficacy in a real-world environment where different users can have different preferences.

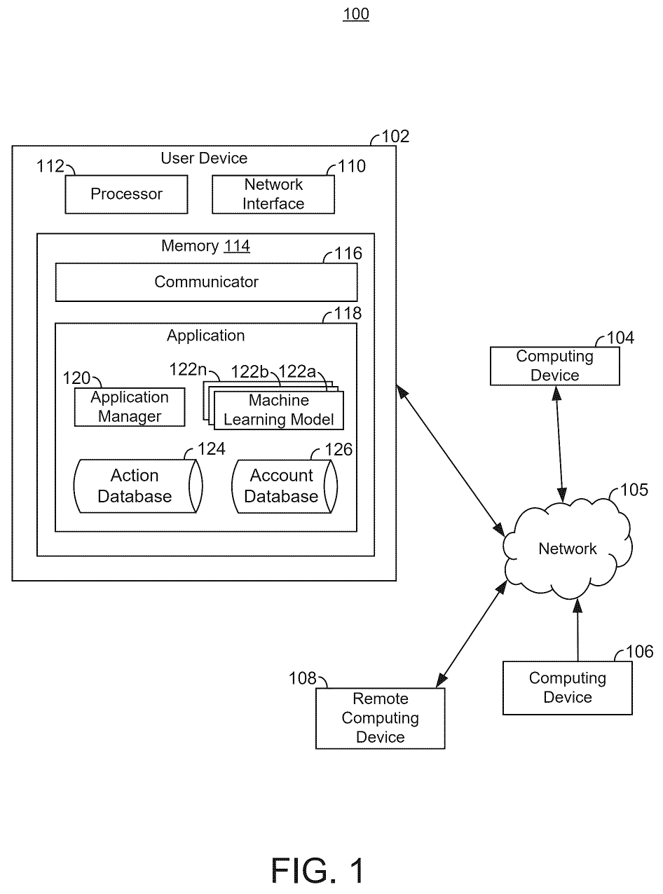

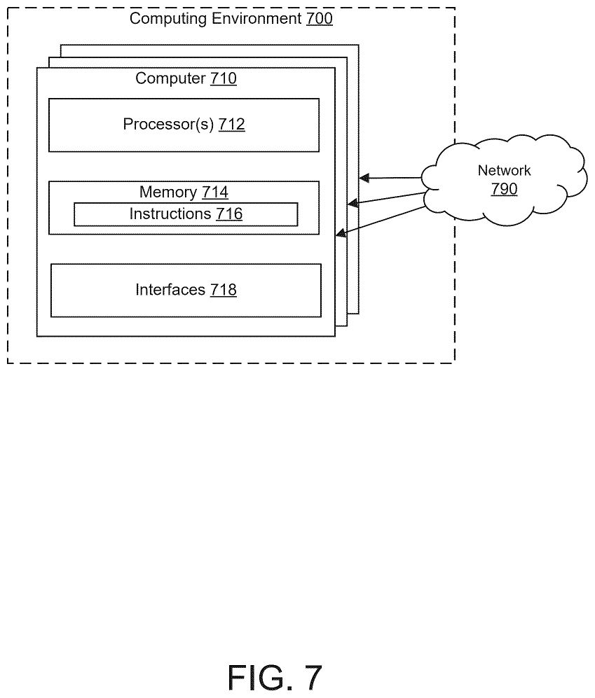

For example, FIG. 1 illustrates an example system 100 for collaborative machine learning model generation, in accordance with an implementation. In brief overview, the system 100 can include a user device 102, a computing device 104, a computing device 106, and/or a remote computing device 108. The user device 102, the computing device 104, the computing device 106, and/or the remote computing device 108 can each include one or more aspects or features described elsewhere herein, such as in reference to the computing environment 700 of FIG. 7. The user device 102 can be configured to execute an application stored locally on the user device 102 to consolidate the learning of machine learning models trained to generate recommendations for potential actions on or at different computing devices (e.g., the computing devices 104 and 106) into a single machine learning model. The user device 102 can then continue to train the consolidated machine learning model based on predictions and selections made locally on or at the user device 102. Using the shared learning of training performed at different computing devices, the user device 102 can improve the accuracy of the machine learning model in generating recommendations for potential actions for a user. In doing so, the user device 102 can configure the machine learning model to handle complex relationships between features when generating recommendations for potential actions. The system 100 may include more, fewer, or different components than shown in FIG. 1.

The user device 102, the computing device 104, the computing device 106, and/or the remote computing device 108 can include or execute on one or more processors or computing devices and/or communicate via a network 105. The network 105 can include computer networks such as the Internet, local, wide, metro, or other area networks, intranets, satellite networks, and other communication networks, such as voice or data mobile telephone networks. The network 105 can be used to access information resources such as web pages, websites, domain names, or uniform resource locators that can be presented, output, rendered, or displayed on at least one computing device (e.g., the user device 102, the computing device 104, the computing device 106, and/or the remote computing device 108), such as a laptop, desktop, tablet, personal digital assistant, smartphone, portable computer, or speaker.

The user device 102, the computing device 104, the computing device 106, and/or the remote computing device 108 can include (e.g., each include) or utilize at least one processing unit or other logic devices such as a programmable logic array engine or a module configured to communicate with one another or other resources or databases. As described herein, computers can be described as computers, computing devices, user devices, or client devices. The user device 102, the computing device 104, the computing device 106, and/or the remote computing device 108 may each contain a processor and a memory. The components of the user device 102, the computing device 104, the computing device 106, and/or the remote computing device 108 can be separate components or a single component. The system 100 and its components can include hardware elements, such as one or more processors, logic devices, or circuits.

The user device 102, the computing device 104, and/or the computing device 106 can each be an electronic computing device (e.g., a cellular phone, a laptop, a tablet, or any other type of computing device). The user device 102, the computing device 104, and/or the computing device 106 can each include a display with a microphone, a speaker, a keyboard, a touchscreen, or any other type of input/output device.

Users can access a platform provided by the remote computing device 108 through the user device 102, the computing device 104, and/or the computing device 106 to view potential actions (e.g., an action associated with software running or a service provided by the user device 102, the remote computing device 108, or another, or entities associated therewith) requested by the users and/or otherwise manage an account the user has with an institution (e.g., a social media institution, a retail institution, a financial institution, another institution, or combinations thereof) that manages an application stored locally on each of the user device 102, the computing device 104, and/or the computing device 106. In one example, a user of the computing device 104 can provide an input into the computing device 106 requesting one or more potential actions of a particular type. The computing device 106 can execute an application to retrieve multiple potential actions of the requested type from the remote computing device 108. The remote computing device 108 can transmit potential actions of the requested type to the computing device 104. The computing device 104 can execute a machine learning model to select one or more potential actions from the received potential actions and present the selected one or more potential actions to the user. The user can select one of the presented potential actions. In response to the user's selection, the computing device 104 can transmit the selected potential action to the remote computing device 108 to complete through the user's account with the platform provided by the remote computing device 108.

The computing devices 104 and 106 can each train a machine learning model (e.g., a neural network, a support vector machine, a random forest, etc.) to generate recommendations for potential actions. For example, the computing device 104 can store and execute an application that is configured to communicate with the remote computing device 108. The application can be configured to access the platform hosted by the remote computing device 108 that is configured to manage an account with an associated entity. Through the application, the computing device 104 can execute the machine learning model using an account identifier of an account and/or historical actions performed through the account to generate individual recommendations (e.g., records or lists) identifying sets of potential actions (e.g., sets of potential actions selected from a plurality of actions the computing device 104 receives or retrieves from the remote computing device 108) and present the sets of potential actions to a user of the computing device 104. A set of potential actions can be or include one or more potential actions of a specific type (e.g., a specific action type), such as a specific type of action, an action with specific attributes or values, etc., which may be input by a user into the computing device 104 to initiate the process of generating a recommendation for the set of potential actions. The user can input a selection of one or more potential actions from each of the sets of potential actions or select an option or element indicating not to select any of the potential actions. The computing device 104 can receive the selections and train the machine learning model based on the selections, such as by using back-propagation techniques using the selections as labels or the ground truth and based on one or more differences between the output sets of potential actions and the selections of potential actions and/or selections indicating not to select any potential action by the user. The computing device 104 can adjust the weights and/or parameters of the machine learning model based on the user's selections over time to train the machine learning model. Thus, the user device 102 can generate individualized recommendations for sets of potential actions for the user. The computing device 106 can train a different machine learning model in the same or a similar manner using an application stored locally on the computing device 106, such as by using an account identifier for a different account and user and/or historical actions performed through the account and user.

The computing devices 104 and 106 can transmit the machine learning models trained locally at the respective computing devices 104 and 106 to the user device 102. For example, subsequent to training the respective machine learning models based on selections (or non-selections) of potential actions made by users of the computing devices 104 and 106, the computing devices 104 and 106 can transmit the machine learning models to the user device 102. The computing devices 104 and 106 can transmit the machine learning models to the user device 102 responsive to determining the machine learning models are accurate to at least an accuracy threshold (which may be determined based on a number, portion, or percentage of recommendations generated by the machine learning models from which a user selected a potential action, in some cases compared with the number of recommendations for which the user did not select a potential action) and/or responsive to a request from the user device 102. In some embodiments, the computing devices 104 and 106 can transmit the respective machine learning models to the user device 102 responsive to a user input at the respective computing devices 104 and 106. The computing devices 104 and 106 can transmit the machine learning models to the user device 102 directly through the network 105 and/or through the remote computing device 108. The user device 102 can receive the machine learning models and store the machine learning models in memory.

The user device 102 may comprise one or more processors that are configured to receive and train machine learning models to generate recommendations for potential actions to a user accessing the user device 102. The user device 102 may comprise a network interface 110, a processor 112, and/or memory 114. The user device 102 may communicate with the computing device 106 and/or the computing device 106 via the network interface 110, which may be or include one or more antennas or other network device that enables communication across a network and/or with other devices. The processor 112 may be or include an ASIC, one or more FPGAs, a DSP, circuits containing one or more processing components, circuitry for supporting a microprocessor, a group of processing components, or other suitable electronic processing components. In some embodiments, the processor 112 may execute computer code or modules (e.g., executable code, object code, source code, script code, machine code, etc.) stored in memory 114 to facilitate the activities described herein. The memory 114 may be any volatile or non-volatile computer-readable storage medium capable of storing data or computer code.

The memory 114 may include a communicator 116 and an application 118. The application 118 can include an application manager 120, machine learning models 122a-n (individually machine learning model 122, and, in groups, machine learning models 122), a action database 124, and/or an account database 126. In brief overview, the components 116-124 may receive a first machine learning model (e.g., the machine learning model 122a) from the computing device 104 and a second machine learning model (e.g., the machine learning model 122b) from the computing device 106. The components 116-122 can execute the first machine learning model and the second machine learning model to generate recommendations for potential actions. The components 116-122 can train the second machine learning model using the recommendations generated by the first machine learning model as a ground truth. The components 116-122 can use the second machine learning model to generate recommendations for potential actions for a user accessing the user device 102. In this way, the components 116-122 can integrate multiple machine learning models trained with different training data or different users to generate a new machine learning model that is configured to generate more accurate recommendations for potential actions and/or take into account more complex relationships between features of an input.

The action database 124 can be or include a relational database or a graphical database. The action database 124 can include action data for actions performed by different accounts (e.g., actions performed by entities associated with the accounts). The accounts can be accounts associated with or managed by the institution that owns or manages the remote computing device 108, for example. The accounts can correspond with actions or store data of or for individual users. The action data can include, for individual actions performed through the accounts, an action amount (e.g., values or parameters associated with the action), a timestamp indicating the time and/or date in which the action was performed or completed, identifications of the one or more accounts participating in the action (e.g., the action may involve an interaction with another account), the location of the action, a code for the action, and/or any other data regarding the actions. The action database 124 can store the action data in records and/or data structures (e.g., tables).

The user device 102 can store data for actions in the action database 124 over time. For example, the user device 102 can receive action data from the computers and/or servers that manage or otherwise facilitate the actions as the actions are processed and/or completed. Responsive to receiving the action data, the user device 102 can store the action data in the action database 124 in records for the individual actions. The user device 102 can store the records in the data structures within the action database 124 for the accounts participating in the actions. The user device 102 can generate and store such records for actions as the user device 102 receives action data for the actions over time. In some cases, the action database 124 may only include action data for actions performed through the application 118 and/or the account of the user accessing the application 118. In some cases, the action database 124 is stored at the remote computing device 108, and the user device 102 requests action data from the remote computing device to retrieve action data.

The account database 126 can be or include a relational or graphical database configured to store data (e.g., account data) for different accounts. The account database 126 can store records (e.g., tables or data structures) for each account that includes data for the account. The account data can include, for example, name, age, gender, time the account has been open, subscription information if the account is a subscription, etc. Each record can include one or more field-value pairs that each correspond to a different type of data.

The communicator 116 may comprise programmable instructions that, upon execution, cause the processor 112 to communicate with the computing device 106, the computing device 106, and/or any other computing device. The communicator 116 can be or include an application programming interface (API) that facilitates communication between the user device 102 (e.g., via the network interface 110 of the user device 102) and other computing devices. The communicator 116 may communicate with the computing device 104, the computing device 106, the remote computing device 108, and/or any other computing devices across a network (e.g., the network 105).

In one example, the communicator 116 can establish a connection with a computing device (e.g., the computing device 104 or the computing device 106). The communicator 116 can establish the connection with the computing device over the network 105. To do so, the communicator 116 can communicate with the computing device across the network 105. In one example, the communicator 116 can transmit a syn packet to the computing device 106 (or vice versa) and establish the connection using a TLS handshaking protocol. The communicator 116 can use any handshaking protocol to establish a connection with the computing device 106. The user device 102 can communicate with the computing device 106 over the established connection.

The application 118 may comprise programmable instructions that, upon execution, cause the processor 112 to facilitate communication with the remote computing device 108 to enable a user to access the platform provided by the remote computing device 108. In some embodiments, the application 118 can be an API and be a part of or include the communicator 116. The application 118 can generate user interfaces with data from the remote computing device 108 and present the user interfaces on a display of the user device 102. In some cases, the application 118 can use machine learning models or machine learning techniques to select a set of potential actions to include in a user interface and present the user interface on the display. A user can select a potential action from the set of potential actions, and the application 118 can transmit the selection (e.g., an identification of the selected potential action) to the remote computing device 108. The remote computing device 108 can receive the selection and facilitate or complete the action.

The application manager 120 of the application 118 can receive the machine learning models from the computing devices 104 and 106. The machine learning models received from the computing devices 104 and 106 can be the machine learning models 122a and 122b, respectively. The application manager 120 may comprise programmable instructions that, upon execution, cause the processor 112 to perform different operations using the application 118, such as training and/or executing the machine learning models 122 to generate sets of potential actions or facilitate a user experience of the user accessing the application 118 on the user device 102. The application manager 120 can communicate or interact with the remote computing device 108 to transmit and/or receive data for an account of a user accessing the user device 102.

The application manager 120 can manage the machine learning models 122. In doing so, the application manager 120 can facilitate reception and/or retrieval of the machine learning models 122 from other computing devices. For example, the application manager 120 can receive the machine learning models 122a and 122b from the computing devices 104 and/or 106 after the computing devices 104 and/or 106 transmit the respective machine learning models 122a and 122b. The application manager 120 can receive or retrieve the machine learning models 122a and 122b from the computing devices 104 and/or 106 responsive to an input request at the user device 102. For instance, the user accessing the user device 102 can input a request for a machine learning model that is configured to generate recommendations for sets of potential actions to provide to the user. Responsive to the input, the application manager 120 can transmit a message to the remote computing device 108 and/or the computing devices 104 and/or 106 for a machine learning model per the request. In cases in which the application manager 120 transmits the request to the remote computing device 108, the remote computing device 108 can receive the request and prompt (e.g., transmit a message to) the computing devices 104 and/or 106 for the requested machine learning model. The computing devices 104 and/or 106 can receive the request from the application manager 120 and/or the remote computing device 108 and automatically transmit the machine learning models 122a and 122b to the user device 102 and/or present a message (e.g., a push notification or mailbox message) at user interfaces displayed on the computing devices 106 and/or 108 indicating the request. In cases in which the computing devices 104 and/or 106 do not automatically transmit the machine learning models 122a and 122b to the user device 102, the computing devices 106 and/or 108 can transmit the machine learning models 122a and 122b to the user device 102 responsive to receiving an input from at the respective computing devices 104 and/or 106 indicating to share or transmit the machine learning models 122a and 122b to the user device 102. The computing devices 104 and/or 106 can transmit the machine learning models 122a and 122b to the user device 102 by transmitting copies of the machine learning models 122a and 122b such that the computing devices 104 and/or 106 can continue to use the machine learning models 122a and 122b to generate recommendations for sets of potential actions locally. The application manager 120 can also manage machine learning models local to the user device 102, such as by facilitating the creation, updating, use, and destruction of such models as relevant.

In some embodiments, the computing devices 104 and/or 106 can transmit the machine learning models 122 to the user device 102 without receiving a request or message that originated from the user device 102. For example, users accessing the computing devices 104 and/or 106 can select an option to share or transmit the machine learning models 122 to the user device 102. The users can do so, for example, by inputting an identifier (e.g., a numerical or alphanumerical identifier) of the account of the user accessing the user device 102 and/or an identifier (e.g., an Internet Protocol address, a MAC address, etc.) of the user device 102. The computing devices 104 and/or 106 can receive the input and transmit the machine learning models 122 to the user device 102 responsive to the input, such as based on the identifiers of the input.

In some embodiments, the user device 102 can request a machine learning model that is configured to generate recommendations of potential actions for a specific type of action. For example, the user accessing the user device 102 can receive an input indicating a type of action. Based on the input, the user device 102 can transmit a request for a machine learning model that is configured to generate recommendations of the potential actions for the specific type of action. In another example, users accessing the computing devices 104 and/or 106 can indicate a type of action in an input to the respective computing devices 104 and/or 106. The computing devices 104 and/or 106 can identify the type of action from the request or input and transmit a machine learning model configured to generate recommendations of potential actions for the input type of action to the user device 102.

The application manager 120 can receive the machine learning models 122 from the computing devices 104 and/or 106 and store the machine learning models 122 in memory 114. In some cases, the application manager 120 can store the machine learning models 122 in memory 114 with indications of the types of potential actions for which the machine learning models 122 are configured to generate recommendations. The application manager 120 can receive and/or retrieve any number of machine learning models from different computing devices. The retrieved machine learning models can be configured to generate recommendations for potential actions of any type.

The machine learning models 122 may each be or include a neural network, a support vector machine, a random forest, a large language model, or any other type of machine learning model. The machine learning models 122 may be or include machine learning models that have been received or retrieved from different computing devices, such as the computing devices 104 and/or 106. The machine learning models 122 may be or include models that are each configured to generate recommendations for specific types of actions and/or models that are agnostic to the types of the actions. The machine learning models 122 may have been trained at the other computing devices, such as by users accessing the computing devices, to make selections of potential actions prior to being transmitted to the user device 102. The application manager 120 may further train one or more of the machine learning models 122 locally after receiving the machine learning models 122.

The application manager 120 can integrate or combine the machine learning models 122 together. For example, the application manager 120 can use outputs from the machine learning model 122a received from the computing device 104 to train the machine learning model 122b received from the computing device 106. The application manager 120 may do so using the outputs of the machine learning model 122a as a ground truth for outputs from the machine learning model 122b that were both generated based on the same input. For instance, the user accessing the user device 102 may select an option at the user device 102 to indicate to use the machine learning models 122a as the ground truth to train the machine learning model 122b. The application manager 120 can identify the selection and retrieve the selected machine learning models 122a and 122b from memory 114. The application manager 120 may then use the machine learning model 122a to train or finetune the machine learning model 122b based on the outputs of both machine learning models 122a and 122b.

The application manager 120 may use a training data set of account identifiers and/or action data of historical actions performed by the accounts associated with the account identifiers to train the machine learning model 122b. For example, the application manager 120 may generate a training data set that includes multiple instances that each include an account identifier and/or historical action data of actions performed through the account. For each instance, the application manager 120 may input the account identifier and/or the historical action of the instance into both the machine learning model 122a and the machine learning model 122b (e.g., the same input into both machine learning models). The application manager 120 can also input a plurality of potential actions of the instance for the training data set into the machine learning models 122a and 122b. The application manager 120 may execute the machine learning models 122a and 122b based on the input. The executions can cause each of the machine learning models 122a and 122b to generate a recommendation identifying a set of potential actions.

The application manager 120 can use the set of potential actions of the recommendation generated by the machine learning model 122a as a ground truth to train the machine learning model 122b. For example, the application manager 120 can compare the set of potential actions of the recommendation generated by the machine learning model 122b to the set of potential actions of the recommendation generated by the machine learning model 122a, in some cases using a loss function. Based on the comparison, the application manager 120 can determine one or more differences between the two sets of potential actions. The application manager 120 can use back-propagation techniques on the machine learning model 122b (e.g., only the machine learning model 122b) based on the differences to adjust the weights and/or parameters of the machine learning model 122b. In doing so, the application manager 120 can adjust the weights and/or parameters of the machine learning model 122b such that the weights and/or parameters would cause the machine learning model 122b to generate recommendations of potential actions that are similar to recommendations generated by the machine learning model 122a. The application manager 120 can train the machine learning model 122b in this way for any number of instances of training data. Accordingly, the application manager 120 can train the machine learning model 122b, which may have already been trained according to the preferences of the user at the computing device 104, to accommodate the preferences of the user at the computing device 106. This method of training can enable the machine learning model 122b to generate more accurate recommendations and/or recommendations based on more complex relationships that may not be apparent to a model that was trained based only on selections by a single user.

The application manager 120 may use the machine learning model 122b to generate recommendations of sets of potential actions for the user accessing the user device 102. For example, the user can access the application 118 through an account that the user has with the application 118. In doing so, the user can select an option to access a web page or user interface that corresponds to a action that the user is seeking to complete. The user can provide an input (e.g., via an input/output device, such as a mouse, keyboard, or touch screen) into the web page or user interface that requests one or more potential actions. The application manager 120 can receive the input as a request for the one or more potential actions. Responsive to the request, the application manager 120 can retrieve the machine learning model 122b (e.g., the machine learning model 122b that has been trained based on recommendations by the machine learning model 122a) from memory. The application manager 120 can execute the machine learning model 122b using an account identifier of the user account associated with the user accessing the user device 102 to generate a recommendation comprising the one or more potential actions.

To generate the recommendation comprising the one or more potential actions, the application manager 120 may retrieve available potential actions from the remote computing device 108. For example, responsive to the request for the one or more potential actions, the application manager 120 can transmit a message to the remote computing device 108 for potential actions. In some cases, the request can include one or more attributes (e.g., action attributes) for the potential actions. In such cases, the application manager 120 can include the attributes in the request to the remote computing device 108.

For example, the application manager 120 may be configured to generate a user interface on the display of the user device 102. The user interface may be or include a set of options or elements that correspond to one or more different types of actions (e.g., action types) and/or attributes. A user accessing the user device 102 and the application 118 through an account associated with (e.g., owned by) the user can select one of the options or elements for a type of action. Responsive to the selection, the application manager 120 can transmit a request for potential actions to the remote computing device 108, in some cases including any selected attributes and/or the selected types of actions. The remote computing device 108 can receive the request and identify potential actions that the remote computing device 108 has stored in memory 114. The remote computing device 108 can identify potential actions that have attributes that match the attributes in the request. The remote computing device 108 can transmit any identified potential actions to the user device 102. The application manager 120 can receive the potential actions and use the potential actions as input into the machine learning model 122b to use to generate the recommendation of the set of potential actions requested by the user.

The application manager 120 may generate a feature vector to use as input into the machine learning model 122b to generate the recommendation of the set of potential actions. To do so, the application manager 120 may use the account identifier of the account through which the user is accessing the application 118. For example, the application manager 120 may query the action database 124 using the account identifier as a key to identify actions performed by or through the account. The application manager 120 may retrieve action data (e.g., time, date, value, code, location of completion, etc.) of all of the identified actions, of a defined number of the most recent identified actions, or of actions completed within an immediately previous defined time period (e.g., the previous year). The application manager 120 can include the retrieved action data in the feature vector. In another example, the application manager 120 may query the account database 126 using the account identifier as a key to identify account data (e.g., name, age, gender, time the account has been open, subscription information if the account is a subscription, etc.) of the account. The application manager 120 can include the retrieved account data in the feature vector. In some cases, the application manager 120 can include the account identifier itself in the feature vector. The application manager 120 can include any combination or permutation of such data in the feature vector. The application manager 120 can generate the feature vector with the data, in some cases by normalizing the values or converting the values into a format compatible with the machine learning model 122b (e.g., a numerical format using a table).

The application manager 120 can execute the machine learning model 122b using the feature vector as input with the potential actions received from the remote computing device 108. The execution of the machine learning model 122b can cause the machine learning model 122b to select a set of potential actions from the input potential actions to recommend to the user. The application manager 120 can generate a record (e.g., a matrix, a table, file, user interface, notification, alert, data structure, etc.) that includes the set of potential actions (e.g., identifications of the set of potential actions and/or any attributes of the potential actions) of the recommendation. The application manager 120 can present the record including the set of potential actions on a display (e.g., on a second user interface) of the user device 102 to the user.

The application manager 120 can facilitate completion of the selected potential action. For example, responsive to receiving the selection of the potential action, the application manager 120 can transmit a message to the remote computing device 108 indicating the potential action was selected. In some embodiments, the selection can indicate that no potential actions were selected from the set of potential actions. The message can include the identification or identifier of the account through which the potential action was selected, an identification of the potential action, and/or any attributes of the potential action. The remote computing device 108 can receive the message and transmit messages to any entities that correspond with (e.g., that offered) the potential action. The remote computing device 108 can update account data of the account to indicate that the user selected the potential action. Thus, the application manager 120 and the remote computing device 108 can facilitate completion of the selected potential action.

The application manager 120 can train the machine learning model 122b based on the selection of the potential action. For example, the application manager 120 can use back-propagation techniques on the machine learning model 122b by using the selected potential action as the ground truth and determining a difference between the selected potential action and the other potential actions that the machine learning model 122b selected to include in the recommendation. The application manager 120 can adjust the weights and/or parameters of the machine learning model 122b based on the difference to train the machine learning model 122b to generate recommendations that are more similar to the selected potential action. The application manager 120 can continue to train the machine learning model 122b in this way over time based on different requests to cause the machine learning model 122b to generate recommendations based on a blend of training from the users of the user device 102 and the computing devices 104 and 106. Thus, the application manager 120 can train the machine learning model 122b to generate recommendations based on more complex relationships between features.

In some cases, the application manager 120 can transmit the machine learning model 122b to another computing device. The application manager 120 can transmit the machine learning model 122b to the new computing device responsive to determining the machine learning model 122b is trained to at least an accuracy threshold by the user of the user device 102. In some cases, the application manager 120 can transmit (e.g., directly transmit or transmit through the remote computing device 108) the machine learning model 122b (e.g., after training the machine learning model 122b at the user device 102) to the computing device in response to receiving a request from the computing device and/or in response to receiving an input at a user interface presented at the user device 102, similar to how the computing devices 104 and/or 106 transmitted the machine learning models 122a and/or 122b to the user device 102. The computing device can receive the twice-trained (e.g., trained by two different users and/or by two different computing devices) machine learning model 122b and operate to generate recommendations of potential actions for a user of the computing device in a similar manner to the user device 102, as described herein. Thus, the system 100 can facilitate a chain of training a machine learning model at different computing devices, improving the accuracy and/or complexity with each training at a different computing device. In some embodiments, the computing devices can transmit copies of the machine learning model 122b back to each other after training locally. For instance, the computing device can continue training the machine learning model 122b locally based on selections by the user of the computing device and transmit the further trained machine learning model 122b back to the user device 102. The user device 102 may then use the thrice-trained (e.g., trained by three different users and/or by three different computing devices) machine learning model 122b to generate recommendations of potential actions.

In some cases, the application manager 120 may use machine learning models that are configured or trained to generate recommendations for specific types of actions. For example, a user may provide an input into a user interface to access a specific web page or user interface provided by the application 118 that corresponds to a specific type of action or for a recommendation for potential actions. The application manager 120 may identify the type of action of the input as a request and retrieve a machine learning model 122 from the machine learning models 122 that corresponds to the type of action. The machine learning model 122 may have been trained as described herein based on outputs of another machine learning model trained to generate recommendations of potential actions of the action type. The application manager 120 may include a type of action in a message to the remote computing device 108 and the remote computing device 108 may transmit potential actions of the type to the user device 102. The application manager 120 may execute the machine learning model 122 to select one or more potential actions received from the remote computing device 108 and generate a recommendation identifying the selected one or more potential actions. The application manager 120 may display the recommendation on a user interface displayed on the user device 102. The user accessing the user device 102 may select a potential action from the one or more potential actions and operate as described herein. By using machine learning models that are configured specific to individual action types, the user device 102 may further improve the accuracy of the recommendations that the application 118 generates.

In some embodiments, the application manager 120 may train the machine learning models 122a and 122b to generate recommendations of sets of different types of potential actions. For example, the machine learning model 122a can be configured to generate recommendations for sets of potential actions of a first type and the machine learning model 122b can be configured to generate recommendations for sets of potential actions of a second type. The application manager 120 can select which of the machine learning models 122a or 122b to use to generate recommendations based on the request (e.g., the application manager 120 can retrieve and use the machine learning model 122a responsive to a request for a recommendation for potential actions of the first type and retrieve and use the machine learning model 122 responsive to a request for a recommendation for potential actions of the second type). Each of the machine learning models 122a and 122b may be configured to receive the same types of inputs (e.g., the same or identical features of action data, account data, and/or an account identifier). The application manager 120 can train both of the machine learning models 122a and 122b based on the individual recommendations generated by the machine learning models 122a and 122b and the user selections from the recommendations. For instance, for each request for a recommendation, the application manager 120 can execute both of the machine learning models 122a and 122b to generate recommendations of sets of potential actions. The application manager 120 can identify the machine learning model 122 of the machine learning models 122a and 122b that is configured to generate recommendations for the type of action of the request and train the identified machine learning model 122a or 122b based on a selection by the user from the recommended set of potential actions generated by the machine learning model 122a or 122b. The application manager 120 can use the identified machine learning model 122a or 122b as the ground truth and train the other machine learning model 122a or 122b either based on the weights and parameters prior to the training performed based on the selection or based on the adjustment to the weights or parameters of the training made based on the selection. The application manager 120 can train each of the machine learning models 122a and 122b in this way over time to tune the machine learning models 122 based on the user's selections.

Furthermore, training the machine learning models 122a and 122b in this way can train or configure the machine learning models 122a and 122b to generate recommendations for sets of potential actions of new or different types of actions. For instance, the machine learning models 122a and 122b may have initially been configured to generate first and second types of recommendations, respectively. Training the machine learning models 122a and 122b based on recommendations of the other machine learning model 122a or 122b can enable or facilitate the machine learning models 122 to generate recommendations for the other type (e.g., the learned relationships for one type can provide new contextual information for the other or even another type). The machine learning models 122a and 122b may be trained and configured to generate recommendations for any type of actions.

In some embodiments, the application manager 120 can train the machine learning models 122 to generate recommendations for specific types of actions or to generate recommendations for multiple and potentially new type of actions. Doing so can increase the generalization ability of the machine learning models 122 to a group of types of actions (e.g., not just individual types of actions) and adapt the machine learning models 122 to the needs of new users while maintaining or improving performance over time (e.g., avoiding model drift failures in which the performance degrades over time, such as due to changing economic conditions, types of tasks/offers, user base, etc.). For example, the machine learning models 122a and 122b can be trained according to one of the embodiments described above. The user device 102 can transmit the machine learning models 122a and 122b to a new computing device. A user accessing the new computing device can train the machine learning models 122a and 122b based on recommendations generated by the machine learning models 122a and 122b locally on the new computing device and user selections by the user accessing the new computing device. Because the training can occur over time, the machine learning models 122a and 122b can account for changes in behavior by the user (e.g., changes in an environment in which the action takes place can influence a user's responsive to certain types of potential actions, such as offers). Accordingly, the machine learning models 122a and 122b can be resistive to concept drift. Furthermore, by training the machine learning models 122a and 122b in this way, the machine learning models 122a and 122b can be useful when the distribution of contextual features for the new user accessing the machine learning models 122a and 122b differs (e.g., significantly significantly) from the features of the users that initially trained the machine learning models 122a and 122b (e.g., the distribution of age, income, and/or location data of the users that previously trained the machine learning models 122a and 122b may differ significantly from the distribution of age, income, and location data of new users). Thus, the system can adapt to covariate shift that may be present in a changing and/or expanding user base.

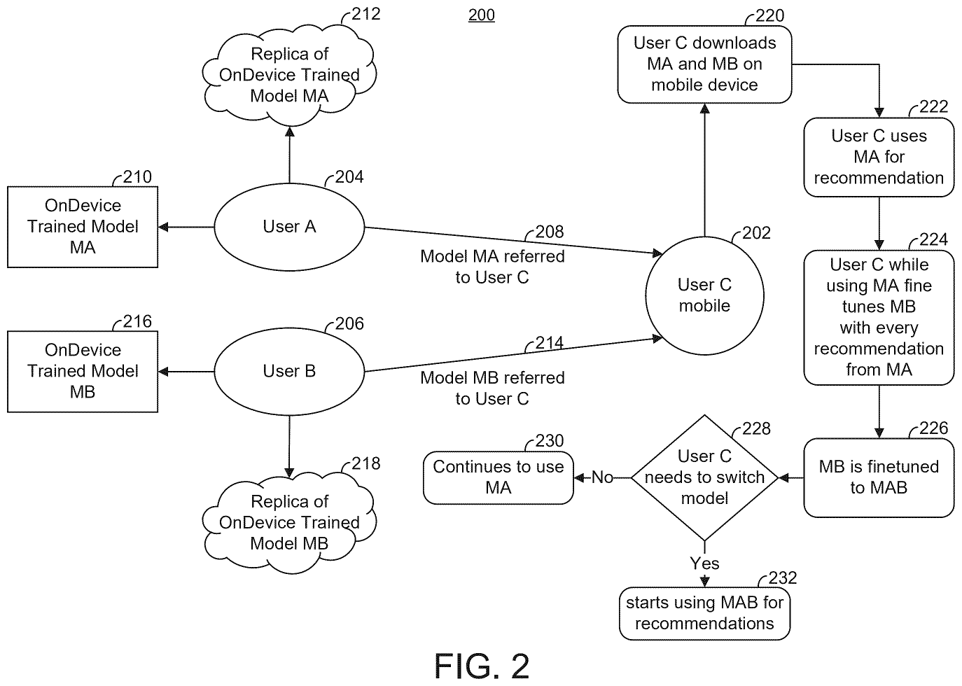

FIG. 2 illustrates a sequence diagram of a sequence 200 for collaborative machine learning model generation, in accordance with an implementation. The sequence 200 can be performed by the components of the system 100, shown and described with reference to FIG. 1. For example, individual operations of the sequence 200 can be performed by a user device 202, a computing device 204, and a computing device 206. The sequence 200 may include more or fewer operations, and the operations may be performed in any order.

In the sequence 200, at an operation 208, the computing device 204 of user A can transmit a trained machine learning model 210 to the user device 202 of user C. The computing device 204 of user A can train the machine learning model 210 to generate recommendations for potential actions (e.g., potential actions of a particular type or potential actions of multiple types) based on selections by or other actions of user A, who may be using the computing device 204 of user A during the training. The computing device 204 of user A can transmit a copy 212 of the machine learning model 210 to a cloud computer for storage and/or for training in a federated learning system. The computing device 204 of user A can transmit the machine learning model 210 (e.g., a copy of the machine learning model 210) to the user device 202 of user C. The computing device 204 of user A can transmit the machine learning model 210 to the user device 202 of user C after being trained based on the actions of user A, for example.

At an operation 214, the computing device 206 of user B can transmit a trained machine learning model 216 to the user device 202 of user C. The computing device 206 of user B can train the machine learning model 216 to generate recommendations for potential actions (e.g., potential actions of a particular type or potential actions of multiple types) based on selections by user B, who may be accessing the computing device 206 during the training. The computing device 206 of user B can transmit a copy 218 of the machine learning model 210 to the cloud computer (e.g., the same cloud computer to which the computing device 204 of user A transmitted the copy 212 of the machine learning model 210). The computing device 206 of user B can transmit the machine learning model 216 (e.g., a copy of the machine learning model 216) to the user device 202. The computing device 206 can transmit the machine learning model 216 to the user device 202 of user C after being trained based on actions of user B, for example.

The user device 202 of user C can receive the machine learning models 210 and 216 and, at an operation 220, download the machine learning models 210 and 216. The user device 202 of user C can download the machine learning models 210 and 216 into an application stored and executed on the user device 202 of user C that is configured to communicate with a remote computing device to access a financial platform provisioned by the remote computing device. At an operation 222, user C accessing the user device 202 may use the machine learning model 210 to generate recommendations for potential actions for user C to select. User C can cause the user device 202 to execute the machine learning model 210 to generate recommendations of sets of potential actions by making selections at user interfaces provided by the application executing on the user device 202. User C can select potential actions from the recommendations and the application can facilitate completion of the selected potential actions.

At an operation 224, the user device 202 of user C can use the recommendations generated by the machine learning model 210 to train the machine learning model 216. For example, while performing the operation 222 and executing the machine learning model 210 to generate recommendations of sets of potential actions, the user device 202 can use the same inputs (e.g., identical inputs) that were input into the machine learning model 210 to generate the recommendations as input into the machine learning model 216. The user device 202 can execute the machine learning model 216 based on the inputs to cause the machine learning model 216 to generate recommendations of sets of potential actions. The user device 202 can compare the sets of potential actions that were recommended by the two machine learning models 210 and 216 based on the same or common inputs to determine one or more differences between the recommendations. The user device 202 can use the sets of potential actions of recommendation generated by the machine learning model 210 as the ground truth and train the machine learning model 216 based on differences between the sets of potential actions of recommendations generated by the two machine learning models 210 and 216. The user device 202 can perform operations 222 and 224 over time as the user requests recommendations for sets of potential actions to train the machine learning model 216 to generate recommendations similar to the machine learning model 210. In doing so, at an operation 226, the user device 202 can train the machine learning model 216 to have weights that are biased to be a mixture of the weights of the machine learning models 210 and 216 that the user device 202 originally received.

At an operation 228, the user device 202 of user C determines whether to switch machine learning models to use to generate recommendations for potential actions. The user device 202 can do so by determining whether the user device 202 received an indication from user C to use the machine learning model 216 (e.g., the machine learning model 216 after training to be similar to the machine learning model 210). In some cases, the user device 202 can determine whether the machine learning model 216 is accurate above a threshold compared with the output recommendations by the machine learning model 210 to determine whether to switch machine learning models to use to generate recommendations. Responsive to determining no input to switch has been received or that the machine learning model 216 is not accurate above the accuracy threshold, at an operation 230, the user device 202 may continue to use the machine learning model 210 to generate recommendations of sets of potential actions and/or train the machine learning model 216 based on the recommendations. However, responsive to receiving an input indicating to switch and/or responsive to determining the machine learning model 216 is accurate above the accuracy threshold, at an operation 232, the user device 202 can initiate, start, or begin using the machine learning model 216 to generate recommendations of potential actions for the user C. In doing so, the user device 202 can continue to train the machine learning model 216 based on recommendations generated by the machine learning model 210 and/or train the machine learning model 216 based on selections from the sets of potential actions that the machine learning model 216 includes in recommendations.

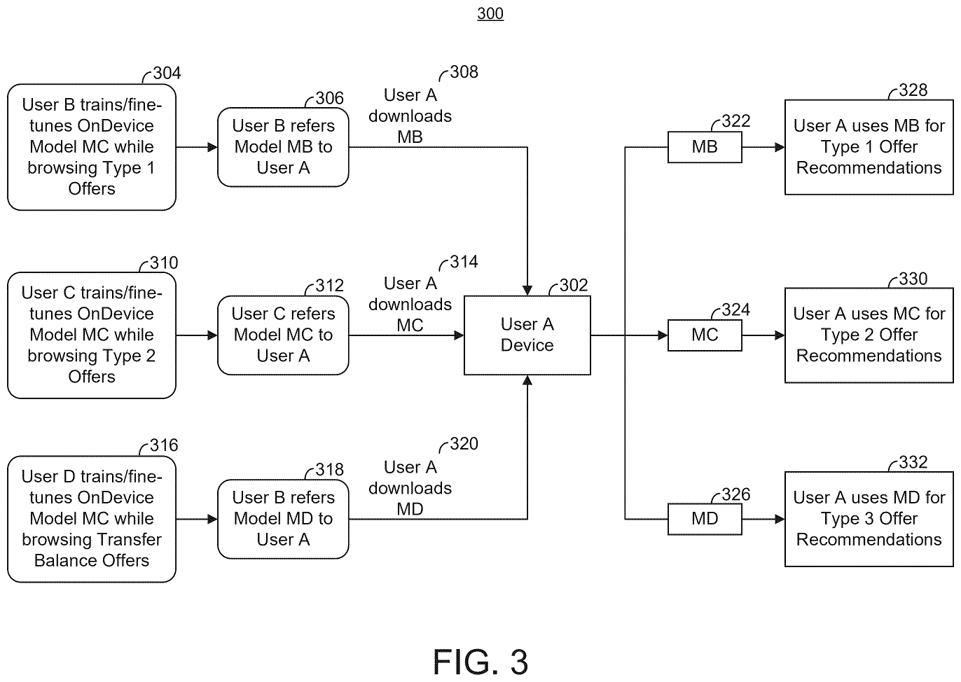

FIG. 3 illustrates a sequence diagram of a sequence 300 for collaborative machine learning model generation, in accordance with an implementation. The sequence 300 can be performed by the components of the system 100, shown and described with reference to FIG. 1. For example, individual operations of the sequence 300 can be performed by a user device 302 and other computing devices configured to execute machine learning models to generate recommendations of potential actions to users. The sequence 300 can involve storing shared machine learning models from different sources and configured to generate recommendations for different types of actions and using the stored machine learning models in response to requests form a user. The sequence 300 may include more or fewer operations, and the operations may be performed in any order.

In the sequence 300, a first computing device, user B can train or finetune a first machine learning model that is configured to generate recommendations for potential actions. User B can train or finetune the first machine learning model by requesting recommendations for potential actions and selecting potential actions to complete from the recommended actions. The first computing device can train the first machine learning model based on the selections over time to better personalize the recommendations for user B. At an operation 306, the first computing device can transmit the trained first machine learning model to the user device 302. At an operation 308, the user device 302 can receive the first machine learning model and download the first machine learning model into memory.

At an operation 310, at a second computing device, user C can train or finetune a second machine learning model that is configured to generate recommendations for potential actions to take. User C can train or finetune the second machine learning model by requesting recommendations for potential actions and selecting potential actions to complete from the recommended actions. The second computing device can train the second machine learning model based on the selections over time to better personalize the recommendations for user C. At an operation 312, the second computing device can transmit the trained second machine learning model to the user device 302. At an operation 314, the user device 302 can receive the second machine learning model and download the second machine learning model into memory.

At an operation 316, at a third computing device, user D can train or finetune a third machine learning model that is configured to generate recommendations for potential balance transfer offers (or any other action type). User D can train or finetune the third machine learning model by requesting recommendations for potential balance transfer offers and selecting potential balance transfer offers to complete from the recommended balance transfer offers. The third computing device can train the third machine learning model based on the selections over time to better personalize the recommendations for user D. At an operation 318, the third computing device can transmit the trained third machine learning model to the user device 302. At an operation 320, the user device 302 can receive the third machine learning model and download the third machine learning model into memory.

The user device 302 can access the different machine learning models based on actions performed or selections by user A when accessing the user device 302. For example, user A may provide an input to access a user interface or web page to view potential actions of specific action types. For example, user A may provide an input related to a specific type of action. Based on the input, the user device 302 can retrieve 322, 324, or 326 one of the machine learning models received and configured to generate recommendations of the requested type of action. At an operation 328, 330, or 332, the user device 302 can execute the retrieved machine learning model to generate a recommendation of potential actions of the requested type. The user device 302 can generate recommendations for any number of types of actions any number of times.

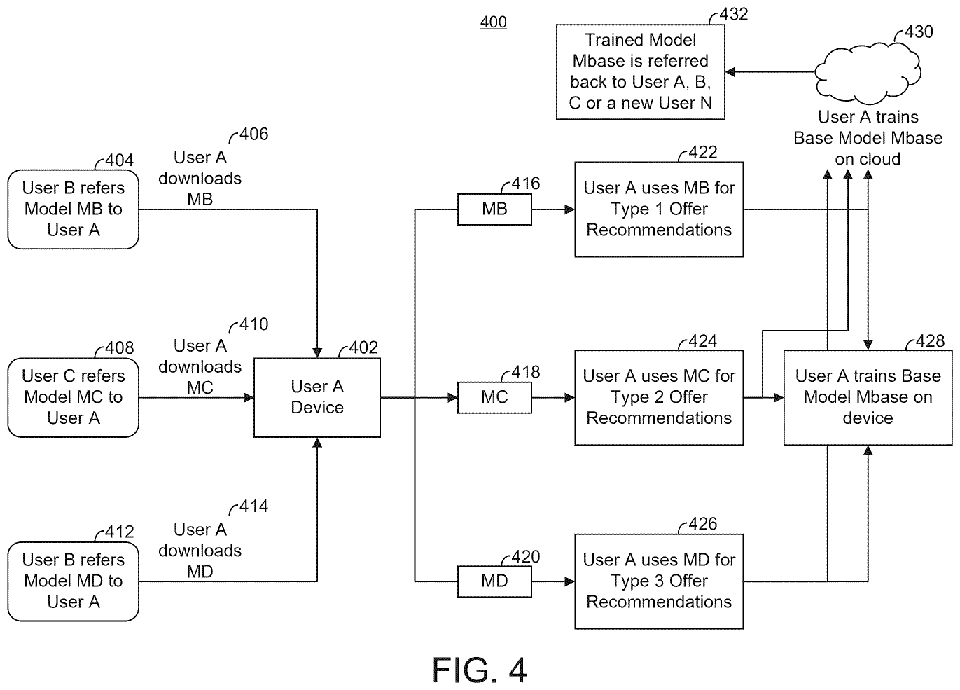

FIG. 4 illustrates a sequence diagram of a sequence 400 for collaborative machine learning model generation, in accordance with an implementation. The sequence 400 can be performed by the components of the system 100, shown and described with reference to FIG. 1. For example, individual operations of the sequence 400 can be performed by a user device 402 and other computing devices configured to execute machine learning models to generate recommendations of potential actions to users. The sequence 400 can involve performing the sequence 300 to receive and use machine learning models that are configured to generate recommendations for potential actions of different types from different computing devices and then train or generate a new or base machine learning model based on the recommendations from the different machine learning models. The sequence 400 may include more or fewer operations, and the operations may be performed in any order.

In the sequence 400, the user device 402 can perform operations 404-426 to receive and use machine learning models that are configured to generate recommendations for potential actions of different types from different computing devices. The user device 402 can perform the operations 404-426 in the same or a similar manner to the manner described with reference to operations 304-332. Each of the machine learning models may be configured to receive the same inputs, but may be trained to have different weights and/or parameters to operate on the inputs to generate recommendations that are specific to the different types of actions. The user device 402 can perform the operations 416-426 over time to cause the machine learning models to generate recommendations for sets of potential actions. User A can select potential actions from the recommendations and then the user device 402 can train the respective machine learning models based on the selections by adjusting the weights and/or parameters of the machine learning models according to the selections.

As user A selects potential actions from the recommendations, at an operation 428, the user device 402 can train a base model based on the training of the other machine learning models. The base model can be configured to receive and process the same inputs as the machine learning models trained in operations 416-426. The user device 402 can be trained to generate recommendations of potential actions for the same types of potential actions.

The user device 402 can train the base model. The user device 402 can train the base model based on the weights and/or parameters of the machine learning models transferred to the user device 402 from other computing devices. In doing so, the user device 402 can instantiate the base model based on an average or median of the weights and/or parameters of the other machine learning models. The user device 402 can then adjust the weights and/or parameters of the base model based on changes in the weights and/or parameters of the other machine learning models, such as by the same or a proportional amount (e.g., the amount of change divided by the total number of machine learning models). The user device 402 may train the base model over time. The user device 402 can train the base model until determining that the base model generates recommendations with an accuracy at least that is at least equal to an accuracy threshold, which may be determined based on the percentage or number of selections of potential action the user makes from generated recommendations, in some cases compared with the number of instances in which the user does not make any selections from a recommendation, as may be how accuracy is determined as described herein throughout. Responsive to determining the base model is accurate to an accuracy threshold (e.g., a predetermined threshold), the user device 402 can use the base model to generate recommendations instead of the machine learning models that are configured to generate recommendations for specific types of actions. Accordingly, the user device 402 can train the base model based on more training data and more interactions between features to generate a more accurate and/or comprehensive model.

The user device 402 can transmit a copy of the base model to a cloud computing device 430. In some embodiments, the user device 402 can transmit updates to the local copy of the base model to the cloud computing device 430 as the user device trains the local copy of the base model. The cloud computing device 430 can update the base model stored at the cloud computing device as the cloud computing device 430 receives the updates. At an operation 432, the cloud computing device 30 can transmit a copy of the trained base model to the computing devices that transmitted the original machine learning models to the user device and/or any other computing devices, either automatically upon updating the base model or responsive to receiving a request for the base model from the respective computing devices.

In a non-limiting example, the user device 402 can receive a number N of previously trained machine learning models from a set of N computing devices (e.g., each computing device can locally train and send the user device 402 a different machine learning model to the user device 402). Each model can be configured to generate recommendations for potential actions of a specific type (e.g., a different type). While using the received machine learning models, user A accessing the user device 402 can train a base model, Mbase, stored locally on the user device 402 based on user actions and recommendations of the different machine learning models as input to generate a more sophisticated model. The user device 402 can transmit the trained base model to the computing devices that provided the initial machine learning model and/or to computing devices that connect with the system. Training the base model in this case can enable or facilitate the base model providing more relevant potential actions to users. In some embodiments, the training can facilitate the base model learning multiple user habits while trading stocks in a single refined model. In some embodiments, the training can facilitate the base model having a better understanding of fraudulent actions from multiple users' behavior.

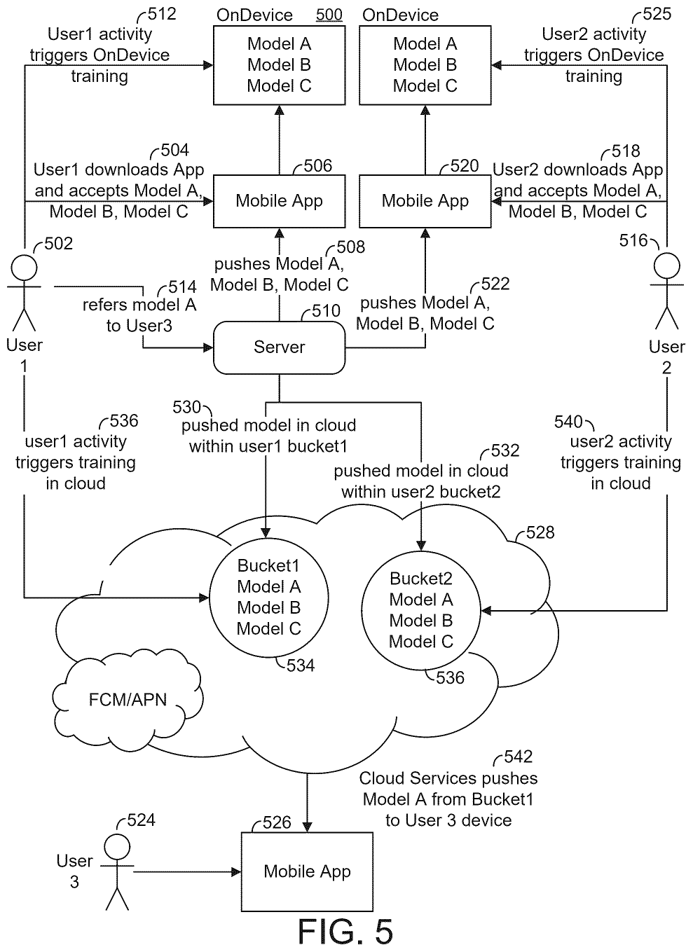

FIG. 5 illustrates a sequence diagram of a sequence 500 for collaborative machine learning model generation, in accordance with an implementation. The sequence 500 can be performed by the components of the system 100, shown and described with reference to FIG. 1. For example, individual operations of the sequence 500 can be performed by a user device 402 and other computing devices configured to execute machine learning models to generate recommendations of potential actions to users. The sequence 500 may include more or fewer operations, and the operations may be performed in any order.

In the sequence 500, a user device 502 can download 504 machine learning models A, B, and C that are each configured to generate recommendations for potential action to an application 506 stored and/or executing on the user device 502. The user device 502 can receive 508 the machine learning models A, B, and C from a server 510. The user device 502 can train 512 one or more of the machine learning models A, B, or C based on selections of potential actions that a user accessing the user device 502 makes based on recommendations from the machine learning models A, B, and C. The user device 502 can transmit 514 the machine learning model A to the server 510, such as after each instance in which the user device 502 trains the machine learning model A, responsive to a request from the server 510, and/or responsive to a request from a user device 524 stored and/or executing an application 526.

Similarly, a user device 516 can download 518 machine learning models A, B, and C to an application 520 stored and/or executing on the user device 516. The user device 516 can receive 522 the machine learning models A, B, and C from the server 510. The user device 516 can train 525 one or more of the machine learning models A, B, or C based on selections of potential actions that a user accessing the user device 516 makes based on recommendations from the machine learning models A, B, and C. The user device 516 can transmit the machine learning model A to the server 510, such as after each instance in which the user device 516 trains the machine learning model A.

The server 510 can transmit the machine learning models A, B, and/or C in a cloud computing system 528. For example, the server 510 can transmit the machine learning models A, B, and/or C to the cloud computing system 528 after receiving the machine learning models A, B, and/or C from the user devices 502 and/or 516. In some embodiments, the server 510 can transmit updates (e.g., changes in the weights and/or parameters) to the machine learning models A, B, and/or C to the cloud computing system 528 for each update to the respective models. The cloud computing system 528 can store the copies of the machine learning models received from the user devices 502 and 516 in logically and/or physically separate buckets 534 and 536 such that the cloud computing system has different versions of the machine learning models A, B, and C stored that have been trained by specific users and/or specific user devices. The user devices 502 and/or 516 can train 538 and/or 540 the corresponding buckets 534 and/or 536 of machine learning models by transmitting any updates to the locally stored versions of the machine learning models to the cloud computing system 528.

The cloud computing system 528 can transmit 542 the machine learning model A to the application 526 executing on the user device 524. The cloud computing system 528 can transmit the machine learning model A to the application 526 in response to the request from application 526 and/or responsive to an update to the machine learning model A as stored in the cloud computing system 528 (e.g., an update to a copy of the machine learning model A flagged to propagate to all computing devices and/or only to specific computing devices). The sequence 500 can facilitate a user-to-server exchange of parameters and/or weights of machine learning models. Thus, the sequence 500 can facilitate user-to-user referrals through the cloud computing system 528 and/or the server 510.

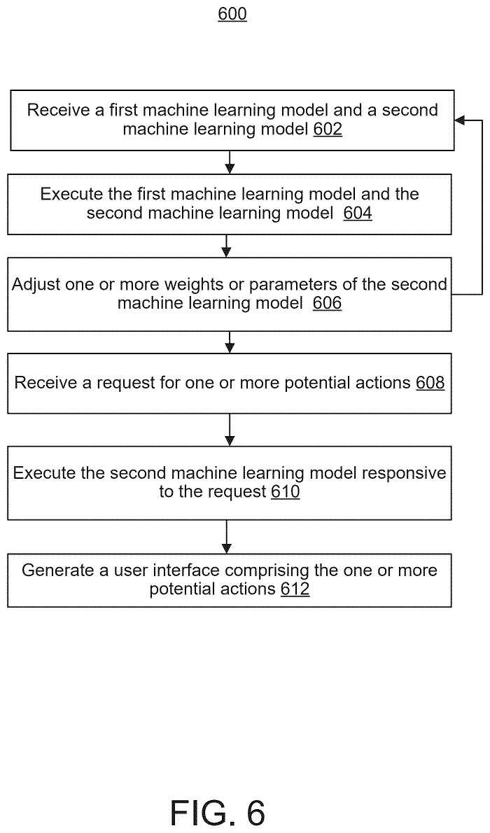

FIG. 6 illustrates an example method for collaborative machine learning model generation, in accordance with an implementation. The method 600 can be performed by a data processing system (e.g., the user device 102, the computing device 106, and/or the computing device 106, each shown and described with reference to FIG. 1, a server system, etc.). The method 600 may include more or fewer operations and the operations may be performed in any order. Performance of the method 600 may enable the data processing system to collaboratively generate, train, and fine tune machine learning models to generate recommendations of sets of potential actions.

In the method 600, at an operation 602, the data processing system receives a first machine learning model and a second machine learning model. The first machine learning model can be configured to generate recommendations that each include a set of potential actions that a user can select to complete. The second machine learning model can also be configured to generate recommendations that each include a set of potential actions that the user can select to complete. The first and second machine learning models can be configured to generate recommendations for sets of potential actions of the same type or of different types. The data processing system can receive the first and second machine learning models using an application. The data processing system can receive the first machine learning model from a first computing device and the second machine learning model from a second computing device. The first and second computing devices can transmit the first and second machine learning models to the data processing system in response to a request from the data processing system and/or in response to receiving inputs from users accessing the respective first and second computing devices.

The first computing device can train the first machine learning model, and the second computing device can train the second machine learning model. The computing devices can train the respective machine learning models based on selections and/or actions that users take at the computing devices. For example, a user may access an application executing on the first computing device via a user interface presented on the first computing device. Via the user interface, the user may provide inputs that include requests for sets of potential actions that the user can perform via their respective accounts with the application. The first computing device may receive the requests and request potential actions from a remote computing device (e.g., a remote server). The first computing device may execute the first computing device using historical action data of the user (e.g., based on an account identifier of the user's account with the application) as input to select a set of potential actions from the received potential actions from the remote computing device. The first machine learning model may generate a recommendation identifying the selected set of potential actions and present the set of potential actions on the user interface to the user. The user may select a potential action from the set of potential actions and the first computing device may train the first machine learning model based on the selection (e.g., using back-propagation techniques). The first computing device can train the first machine learning model in this way over time as the user requests sets of potential actions, thus, the first computing device can train the first machine learning model to be configured to make more accurate recommendations that are specific to the user. The second computing device can similarly train the second machine learning model based on recommendations made by the second machine learning model.

At an operation 604, the data processing system executes the first machine learning model and the second machine learning model. The data processing system can execute the first machine learning model based on a user input by a user accessing the data processing system. For example, the user can input a request for potential actions into a form, user interface, and/or web page being presented by the data processing system. The request can be a request for potential actions similar to the requests received at the first and/or second computing devices. Responsive to receiving the request, the data processing system can use an account identifier of the account through which the user provided the input request to retrieve historical action data of actions performed by the user and/or account data of the user. The data processing system can also retrieve potential actions from the remote computing device responsive to the request. The data processing system can input the historical action data and/or account data into each of the first machine learning model and the second machine learning model and separately execute the first machine learning model and the second machine learning model. Based on the executions, the first and second machine learning models can each select a set of potential actions from the potential actions the data processing system retrieved from the remote computing device. The first and second machine learning models may each generate a recommendation including the set of potential actions that the respective machine learning models selected.

The data processing system can use the recommendations generated by the first and second machine learning models to train the second machine learning model. For example, at an operation 606, the data processing system adjusts one or more weights or parameters of the second machine learning model. The data processing system can adjust the weights or parameters of the second machine learning model based on a difference between the sets of potential actions included in the recommendations generated by the two machine learning models. For instance, the data processing system can use the recommendation generated by the first machine learning model as a ground truth to train the second machine learning model. The data processing system can compare the recommendation including the set of potential actions from the first machine learning model with the recommendation including the set of potential actions from the second machine learning model to determine a difference (e.g., one or more differences) between the two sets of potential actions. The data processing system can use back-propagation techniques on the second machine learning model based on the difference, thus causing the weights and/or parameters of the second machine learning model to be similar to the weights and/or parameters of the first machine learning model. The data processing system can repeat operations 602-606 any number of times to integrate the weights and/or parameters of the two machine learning models together such that the second machine learning model can process or identify more complex relationships in the action data that may not have been apparent based only on the training by the user of the second computing device that initially provided the inputs to train the second machine learning model. In some cases, the data processing system can use the first machine learning model to generate recommendations of sets of potential actions until the second machine learning model is sufficiently trained (e.g., accurate at least to an accuracy threshold compared with the outputs of the first machine learning model, such as based on the number of matching output potential actions from the first machine learning model and the second machine learning model) and/or the data processing system receives an input (e.g., a user input or an input from another computing device) indicating to begin using the second machine learning model to generate recommendations.

At an operation 608, the data processing system receives a request for one or more potential actions. The request can be or include a request for a potential type of action, in some embodiments. The data processing system can receive the request for one or more potential actions as an input from a user interface generated and presented to the user of the data processing system by the application executed by the data processing system. For instance, the data processing system can receive the request when the user accessing the application selects an element (e.g., an element from a drop-down menu indicating types of actions) from a user interface or selects a form or link provided by the application on a user interface (e.g., a first user interface) that is configured to cause the application to provide a new user interface (e.g., a second user interface) with potential actions from which the user can select.

At an operation 610, the data processing system executes the second machine learning model. The data processing system can execute the second machine learning model responsive to the request (e.g., responsive to receiving the request). The data processing system can execute the second machine learning model instead of the first machine learning model responsive to determining a flag has been associated with the second machine learning model in memory, such as based on a user input or responsive to the second machine learning model being accurate to a threshold compared with the first machine learning model. In one example, responsive to the request, the data processing system can receive potential actions from the remote computing device, in some cases potential actions that correspond with a type and/or one or more attributes indicated in the request. The data processing system can retrieve historical action data of actions performed by the user's account (e.g., a defined number of the most recently completed actions or actions performed within a defined time period (e.g., a time period immediately previous to the current time)) using the account identifier of the account. The data processing system can input the retrieved historical action data into the second machine learning model and execute the second machine learning model to cause the second machine learning model to select a set of potential actions from the potential actions retrieved from the remote computing device. The selected set of potential actions can be identified in a recommendation (e.g., an identification of the set of potential actions, such as a list of the selected set of potential actions).

At an operation 612, the data processing system generates a user interface (e.g., a second user interface) that includes the one or more potential actions. The data processing system can generate the user interface by updating the user interface from which the data processing system received the request for potential actions. The data processing system can generate a record comprising the selected set of potential actions and present the record or the set of potential actions on the user interface. The data processing system can present the updated user interface on the display of the data processing system.

After presenting the updated user interface on the display of the data processing system, the user can view and select one of the set of potential actions. Responsive to the selection, the data processing system can transmit an indication or identification of the selected potential action to the remote computing device. The remote computing device may complete the action or otherwise store an indication in the account through which the user selected the potential action indicating that the potential action was selected. The remote computing device can monitor the selected potential action to complete the potential action for the account.

In one aspect, the present disclosure describes a system. The system can include one or more processors of a client device. The one or more processors can be configured by machine-readable instructions stored in memory, wherein, upon execution, the machine-readable instructions cause the one or more processors to receive, via an application executed by the one or more processors, a first machine learning model from a first computing device and a second machine learning model from a second computing device, the first machine learning model trained based on recommendations for potential actions generated by the first machine learning model and selected at the first computing device and the second machine learning model trained based on recommendations for potential actions generated by the second machine learning model and selected at the second computing device; execute, via the application, the first machine learning model to generate a first recommendation for a set of potential actions and the second machine learning model to generate a second recommendation for a set potential actions; adjust, via the application, one or more weights or parameters of the second machine learning model to train the second machine learning model based on a difference between the first recommendation for the set of potential action generated by the first machine learning model and the second recommendation for the set of potential action generated by the second machine learning model; receive, via the application, a request for one or more potential actions at a first user interface presented on a display of the client device; responsive to the request, execute, via the application, the trained second machine learning model using an account identifier of a user account being used to access the application to generate the one or more potential actions; and generate, via the application, a second user interface on the display of the client device comprising the one or more potential actions.

In another aspect, the present disclosure describes a method. The method can include receiving, by one or more processors of a client device via an application, a first machine learning model from a first computing device and a second machine learning model from a second computing device, the first machine learning model trained based on recommendations for potential actions generated by the first machine learning model and selected at the first computing device and the second machine learning model trained based on recommendations for potential actions generated by the second machine learning model and selected at the second computing device; executing, by the one or more processors via the application, the first machine learning model to generate a first recommendation for a potential actions and the second machine learning model to generate a second recommendation for a set potential actions; adjusting, by the one or more processors via the application, one or more weights or parameters of the second machine learning model to train the second machine learning model based on a difference between the first recommendation for the set of potential action generated by the first machine learning model and the second recommendation for the set of potential action generated by the second machine learning model; receiving, by the one or more processors via the application, a request for one or more potential actions at a first user interface presented on a display of the client device; responsive to the request, executing, by the one or more processors via the application, the trained second machine learning model using an account identifier of a user account being used to access the application to generate the one or more potential actions; and generating, by the one or more processors via the application, a second user interface on the display of the client device comprising the one or more potential actions.

In another aspect, the present disclosure describes non-transitory computer-readable media, comprising instructions that, when executed by one or more processors, cause the one or more processors to receive a first machine learning model from a first computing device and a second machine learning model from a second computing device, the first machine learning model trained based on recommendations for potential actions generated by the first machine learning model and selected at the first computing device and the second machine learning model trained based on recommendations for potential actions generated by the second machine learning model and selected at the second computing device; execute the first machine learning model to generate a first recommendation for a set of potential actions and the second machine learning model to generate a second recommendation for a set of potential actions; adjust one or more weights or parameters of the second machine learning model to train the second machine learning model based on a difference between the first recommendation for the set of potential action generated by the first machine learning model and the second recommendation for the set of potential action generated by the second machine learning model; receive a request for one or more potential actions at a first user interface presented on a display of a client device; responsive to the request, execute the trained second machine learning model using an account identifier of a user account being used to access an application of the instructions to generate the one or more potential actions; and generate a second user interface on the display of the client device comprising the one or more potential actions.

The actions described herein can be any of a variety of different kinds of actions. In an example, the action is an input received at a device from a user. An action can be something that is performed as a result of an input from a user. An action can be something done by the user that is detected by the device. In an example, actions are things that can be done with respect to applications or functionality provided by a user device or an accessory of the device. For instance, action can be the activation of a feature or function of the device or software thereof. In addition or instead, the action can be a feature or function of another device, software, capability, or service of another device or entity accessible through the user device. In some examples, the actions are independent of the user device or are performed independent of a device. Example actions or types include a communication action (e.g., sending a message to another device or person), a transaction (e.g., a financial transaction, such as a loan, credit card offering, balance transfer, interaction with a transaction processing system, such as an automated clearinghouse, or another financial transaction), a purchase action (e.g., acting on an advertisement, visiting a store, interacting with a point-of-sale system), an entertainment action (e.g., consuming certain kinds of textual, visual, auditory, or other content), a treatment action (e.g., consuming medicine, taking a therapy action, measuring a health parameter, or another action), a fitness action (e.g., starting a workout) another action, or combinations thereof.

### Large Language Models and Generative Artificial Intelligence

Large language models can be used to implement or enhance aspects described herein. As discussed above, replays, logs, or other data of user interactions with the digital experience can be captured. Such data can be provided as input to a large language model with a prompt to summarize what occurred. Such a summary can be provided as part of the remediation (e.g., to developers to better understand the problem). Further, the large language model can be prompted to identify designs or other changes that may be implemented to address the struggle. In addition to or instead of designs, the large language model may be configured to (e.g., with appropriate prompts and contacts) generate code or instructions (or changes to code or instructions) that address the struggle. A large language model may be used to generate user-specific and struggle- specific messages to the user (e.g., in relation to the above communications).

### Computing Environment

FIG. 7 discloses a computing environment 700 in which aspects of the present disclosure may be implemented. A computing environment 700 is a set of one or more virtual or physical computers 710 that individually or in cooperation achieve tasks, such as implementing one or more aspects described herein. The computers 710 have components that cooperate to cause output based on input. Example computers 710 include desktops, servers, mobile devices (e.g., smart phones and laptops), payment terminals, wearables, virtual/augmented/expanded reality devices, spatial computing devices, virtualized devices, other computers, or combinations thereof. In particular example implementations, the computing environment 700 includes at least one physical computer.

The computing environment 700 may specifically be used to implement one or more aspects described herein. In some examples, one or more of the computers 710 may be implemented as a user device, such as a mobile device, and others of the computers 710 may be used to implement aspects of a machine learning framework useable to train and deploy models exposed to the mobile device or provide other functionality, such as through exposed application programming interfaces.

The computing environment 700 can be arranged in any of a variety of ways. The computers 710 can be local to or remote from other computers 710 of the environment 700. The computing environment 700 can include computers 710 arranged according to client-server models, peer-to-peer models, edge computing models, other models, or combinations thereof.

In many examples, the computers 710 are communicatively coupled with devices internal or external to the computing environment 700 via a network 790. The network 790 is a set of devices that facilitate communication from a sender to a destination, such as by implementing communication protocols. Example networks 790 include local area networks, wide area networks, intranets, or the Internet.

In some implementations, computers 710 can be general-purpose computing devices (e.g., consumer computing devices). In some instances, via hardware or software configuration, computers 710 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 710 include one or more processors 712, memory 714, and one or more interfaces 718. Such components can be virtual, physical, or combinations thereof.

The one or more processors 712 are components that execute instructions, such as instructions that obtain data, process the data, and provide output based on the processing. The one or more processors 712 often obtain instructions and data stored in the memory 714. The one or more processors 712 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 712 include at least one physical processor implemented as an electrical circuit. Example providers processors 712 include INTEL, AMD, QUALCOMM, TEXAS INSTRUMENTS, and APPLE.

The memory 714 is a collection of components configured to store instructions 716 and data for later retrieval and use. The instructions 716 can, when executed by the one or more processors 712, cause execution of one or more operations that implement aspects described herein. In many examples, the memory 714 is a non-transitory computer-readable medium, such as random access memory, read only memory, cache memory, registers, portable memory (e.g., enclosed drives or optical disks), mass storage devices, hard drives, solid state drives, other kinds of memory, or combinations thereof. In certain circumstances, transitory memory 714 can store information encoded in transient signals.

The one or more interfaces 718 are components that facilitate receiving input from and providing output to something external to the computer 710, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors, such as those using the Global Positioning System), other input components, or combinations thereof (e.g., a touch sensitive display). The one or more interfaces 718 can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as WI-FI, cellular, BLUETOOTH, ZIGBEE, or other protocols). One or more of the one or more interfaces 718 can facilitate connection of the computing environment 700 to a network 790.

The computers 710 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries (e.g., libraries that provide functions for obtaining, processing, and presenting data), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Machine Learning Framework

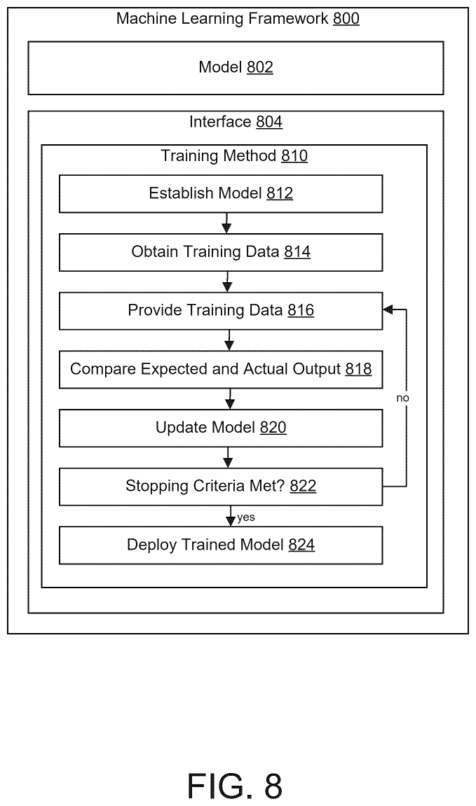

FIG. 8 illustrates an example machine learning framework 800 that techniques described herein may benefit from. A machine learning framework 800 is a collection of software and data that implements artificial intelligence trained to provide output, such as predictive data, based on input. Examples of artificial intelligence that can be implemented with machine learning ways include neural networks (including recurrent neural networks), language models (including so-called “large language models”), generative models, natural language processing models, adversarial networks, decision trees, Markov models, support vector machines, genetic algorithms, others, or combinations thereof. A person of skill in the art, having the benefit of this disclosure, will understand that these artificial intelligence implementations need not be equivalent to each other and may instead select from among them based on the context in which they will be used. Machine learning frameworks 800 or components thereof are often built or refined from existing frameworks, such as TENSORFLOW by GOOGLE, INC. or PYTORCH by the PYTORCH community.

The machine learning framework 800 can include one or more models 802 that are the structured representation of learning and an interface 804 that supports use of the model 802.

The model 802 can take any of a variety of forms. In many examples, the model 802 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 802 can include a representation of memory (e.g., providing long short-term memory functionality). Where the set includes more than one model 802, the models 802 can be linked, cooperate, or compete to provide output.

The interface 804 can include software procedures (e.g., defined in a library) that facilitate the use of the model 802, such as by providing a way to establish and interact with the model 802. For instance, the software procedures can include software for receiving input, preparing input for use (e.g., by performing vector embedding, such as using Word2 Vec, BERT, or another technique), processing the input with the model 802, providing output, training the model 802, performing inference with the model 802, fine tuning the model 802, other procedures, or combinations thereof.

In an example implementation, interface 804 can be used to facilitate a training method 810 that can include operation 812. Operation 812 includes establishing a model 802, such as initializing a model 802. The establishing can include setting up the model 802 for further use (e.g., by training or fine tuning). The model 802 can be initialized with values. In examples, the model 802 can be pretrained. Operation 814 can follow operation 812. Operation 814 includes obtaining training data. In many examples, the training data includes pairs of input and desired output given the input. In supervised or semi-supervised training, the data can be prelabeled, such as by human or automated labelers. In unsupervised learning the training data can be unlabeled. The training data can include validation data used to validate the trained model 802. Operation 816 can follow operation 814. Operation 816 includes providing a portion of the training data to the model 802. This can include providing the training data in a format usable by the model 802. The framework 800 (e.g., via the interface 804) can cause the model 802 to produce an output based on the input. Operation 818 can follow operation 816. Operation 818 includes comparing the expected output with the actual output. In an example, this can include applying a loss function to determine the difference between expected and actual. This value can be used to determine how training is progressing. Operation 820 can follow operation 818. Operation 820 includes updating the model 802 based on the result of the comparison. This can take any of a variety of forms depending on the nature of the model 802. Where the model 802 includes weights, the weights can be modified to increase the likelihood that the model 802 will produce correct output given an input. Depending on the model 802, backpropagation or other techniques can be used to update the model 802. Operation 822 can follow operation 820. Operation 822 includes determining whether a stopping criterion has been reached, such as based on the output of the loss function (e.g., actual value or change in value over time). In addition to, or instead, whether the stopping criterion has been reached can be determined based on a number of training epochs that have occurred or an amount of training data that has been used. In some examples, satisfaction of the stopping criterion can include If the stopping criterion has not been satisfied, the flow of the method can return to operation 814. If the stopping criterion has been satisfied, the flow can move to operation 822. Operation 822 includes deploying the trained model 802 for use in production, such as providing the trained model 802 with real-world input data and produce output data used in a real-world process. The model 802 can be stored in memory 714 of at least one computer 710, or distributed across memories of two or more such computers 710 for production of output data (e.g., predictive data).

### Application of Techniques

Techniques herein may be applicable to improving technological processes of a financial institution, such as technological aspects of actions (e.g., resisting fraud, entering loan agreements, transferring financial instruments, or facilitating payments). Although technology may be related to processes performed by a financial institution, unless otherwise explicitly stated, claimed inventions are not directed to fundamental economic principles, fundamental economic practices, commercial interactions, legal interactions, or other patent ineligible subject matter without something significantly more.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for, and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system, comprising:
one or more processors of a client device and configured by machine-readable instructions stored in memory, wherein, upon execution, the machine-readable instructions cause the one or more processors to:
receive, via an application executed by the one or more processors, a first machine learning model from a first computing device and a second machine learning model from a second computing device, the first machine learning model trained based on recommendations for potential actions generated by the first machine learning model and selected at the first computing device and the second machine learning model trained based on recommendations for potential actions generated by the second machine learning model and selected at the second computing device;
execute, via the application, the first machine learning model to generate a first recommendation for a set of potential actions and the second machine learning model to generate a second recommendation for a set potential actions;
adjust, via the application, one or more weights or parameters of the second machine learning model to train the second machine learning model based on a difference between the first recommendation for the set of potential action generated by the first machine learning model and the second recommendation for the set of potential action generated by the second machine learning model;
receive, via the application, a request for one or more potential actions at a first user interface presented on a display of the client device;
responsive to the request, execute, via the application, the trained second machine learning model using an account identifier of a user account being used to access the application to generate the one or more potential actions; and
generate, via the application, a second user interface on the display of the client device comprising the one or more potential actions.

2. The system of claim 1, wherein the machine-readable instructions cause the one or more processors to:
in response to receiving the request, retrieve, via the application, a plurality of potential actions from a remote server over a communications network,
wherein the one or more processors are configured to execute the trained second machine learning model by executing, via the application, the trained second machine learning model using the account identifier of the user account to select the one or more potential actions from the retrieved plurality of potential actions.

3. The system of claim 1, wherein the machine-readable instructions cause the one or more processors to execute the trained second machine learning model using the account identifier by:
executing, via the application, the second machine learning model using action data of a defined set of actions performed through the account.

4. The system of claim 3, wherein the machine-readable instructions cause the one or more processors to identify, via the application, the defined set of actions by identifying a defined number of the most recent action performed through the account or identifying a set of action performed through the account within a defined time period.

5. The system of claim 1, wherein the first machine learning model is trained to generate a first type of potential actions and the second machine learning model is trained to generate a second type of potential actions.

6. The system of claim 5, wherein the first machine learning model and the second machine learning model are each configured to receive identical types of features as input.

7. The system of claim 1, wherein the machine-readable instructions cause the one or more processors to:
receive, via the application, a selection of a potential action of the one or more potential actions generated by the second machine learning model; and
train, via the application, the second machine learning model based on the selection.

8. The system of claim 7, wherein the machine-readable instructions cause the one or more processors to:
responsive to determining the second machine learning model has an accuracy above an accuracy threshold, transmit, via the application, the second machine learning model to a second computing device configured to use the second machine learning model to generate potential actions.

9. The system of claim 1, wherein the first computing device transmits the first machine learning model to the client device in response to a user selection at a third user interface displayed at the first computing device of an element indicating the first computing device or the account.

10. The system of claim 1, wherein the machine-readable instructions cause the one or more processors to:
transmit, via the application, one or more requests for the first machine learning model and the second machine learning model to a remote server; and
receive, via the application, the first machine learning model and the second machine learning model based on the transmission of the one or more requests for the first machine learning model and the second machine learning model.

11. The system of claim 10, wherein the machine-readable instructions cause the one or more processors to receive the first machine learning model and the second machine learning model from the first computing device and the second computing device through the remote server.

12. The system of claim 1, wherein the machine-readable instructions cause the one or more processors to:
receive, via the application, a selection of a potential action of the one or more potential actions at the second user interface; and
transmit, via the application, the selection of the potential action to a remote computing device.

13. A method, comprising:
receiving, by one or more processors of a client device via an application, a first machine learning model from a first computing device and a second machine learning model from a second computing device, the first machine learning model trained based on recommendations for potential actions generated by the first machine learning model and selected at the first computing device and the second machine learning model trained based on recommendations for potential actions generated by the second machine learning model and selected at the second computing device;
executing, by the one or more processors via the application, the first machine learning model to generate a first recommendation for a potential actions and the second machine learning model to generate a second recommendation for a set potential actions;
adjusting, by the one or more processors via the application, one or more weights or parameters of the second machine learning model to train the second machine learning model based on a difference between the first recommendation for the set of potential action generated by the first machine learning model and the second recommendation for the set of potential action generated by the second machine learning model;
receiving, by the one or more processors via the application, a request for one or more potential actions at a first user interface presented on a display of the client device;
responsive to the request, executing, by the one or more processors via the application, the trained second machine learning model using an account identifier of a user account being used to access the application to generate the one or more potential actions; and
generating, by the one or more processors via the application, a second user interface on the display of the client device comprising the one or more potential actions.

14. The method of claim 13, further comprising:
in response to receiving the request, retrieving, by the one or more processors via the application, a plurality of potential actions from a remote server over a communications network,
wherein executing the trained second machine learning model comprises executing, by the one or more processors via the application, the trained second machine learning model using the account identifier of the user account to select the one or more potential actions from the retrieved plurality of potential actions.

15. The method of claim 13, wherein executing the trained second machine learning model using the account identifier comprises:
executing, by the one or more processors via the application, the second machine learning model using action data of a defined set of actions performed through the account.

16. The method of claim 15, wherein identifying the defined set of actions comprises:
identifying by the one or more processors via the application, a defined number of the most recent action performed through the account or identifying a set of action performed through the account within a defined time period.

17. The method of claim 13, wherein the first machine learning model is trained to generate recommendations for a first type of potential action and the second machine learning model is trained to generate recommendations for a second type of potential action.

18. The method of claim 17, wherein the first machine learning model and the second machine learning model are each configured to receive identical types of features as input.

19. Non-transitory computer-readable media comprising instructions that, when executed by one or more processors, cause the one or more processors to:
receive a first machine learning model from a first computing device and a second machine learning model from a second computing device, the first machine learning model trained based on recommendations for potential actions generated by the first machine learning model and selected at the first computing device and the second machine learning model trained based on recommendations for potential actions generated by the second machine learning model and selected at the second computing device;
execute the first machine learning model to generate a first recommendation for a set of potential actions and the second machine learning model to generate a second recommendation for a set of potential actions;
adjust one or more weights or parameters of the second machine learning model to train the second machine learning model based on a difference between the first recommendation for the set of potential action generated by the first machine learning model and the second recommendation for the set of potential action generated by the second machine learning model;
receive a request for one or more potential actions at a first user interface presented on a display of a client device;
responsive to the request, execute the trained second machine learning model using an account identifier of a user account being used to access an application of the instructions to generate the one or more potential actions; and
generate a second user interface on the display of the client device comprising the one or more potential actions.

20. The non-transitory computer-readable media of claim 19, wherein execution of the instructions further cause the one or more processors to:
in response to receiving the request, retrieve a plurality of potential actions from a remote server over a communications network,
wherein execution of the instructions causes the one or more processors to execute the trained second machine learning model by executing the trained second machine learning model using the account identifier of the user account to select the one or more potential actions from the retrieved plurality of potential actions.
